(19) United States
(12) Patent Application Publication
(10) Pub. No.: US 2019/0011067 A1
(43) Pub. Date: Jan. 10, 2019

(54) METHOD FOR CONNECTING TWO FLEXIBLE TUBULAR CONTAINERS

(71) Applicant: FLECOTEC AG, Badenweiler (DE)

(72) Inventor: Martin KOCH, Neuenburg (DE)

(21) Appl. No.: 16/066,351

(22) PCT Filed: Dec. 9, 2016
(86) PCT No.: PCT/EP2016/002086

§ 371 Date: Jun. 27, 2018

(30) Foreign Application Priority Data
Jan. 19, 2016 (DE) 10 2016 000 513.0

(51) Int. Cl. F16L 31/00; F16L 25/10

(52) U.S. Cl. CPC F16L 31/00; B65D 33/16; F16L 25/10

(57) ABSTRACT

A method for connecting two containers (10, 12), with the steps: 1) folding a first open end region (22) of a first container (10) around a first ring (14) in such a manner that a cuff (26) arises, 2) folding a second open end region (24) of a second container (12) around a second ring (16) in such a manner that a further cuff (28) arises, 3) introducing the one ring (16) into the other ring (14) with its attached container (10), 4) aligning the two rings (14, 16) parallel to and coaxially with each other, 5) bringing the rings (14, 16) into contact with film material (18) clamped between them, and 6) the cuff (28) which is assigned to the ring (16) introduced into the other ring (14) with its container (10), being turned inside out in the direction of the other cuff (26) which has already been folded on the other ring (14).

The invention relates to a method for connecting two flexible, tube-like containers, in particular for environmentally tight connection of two open tubular film end portions. Devices for contamination-free docking of flexible containers are well known from the prior art, for example from EP 1 656 311 B1. However, the known devices consist mainly of several elements, which are combined with one another in a complex manner to connect a flexible container in an optimally environmentally tight and media-conducting manner to a flange or another container. The flexible container is clamped between at least two elements and supported by supports, for example by a circumferential clamping ring, which surrounds all of the elements and thus fixes them to one another.

The class-specific document EP 2 674 657 A1 made known a method for connecting two flexible containers, in particular for environmentally tight connection of two open tubular film end portions, comprising at least the method steps
1.1 everting a first open end of a first flexible container about a first ring,
1.2 everting a second open end of a second flexible container about a second ring,
1.3 subsequent introduction of the first ring through the second ring into the second flexible container,
1.4 subsequent parallel and coaxial alignment of the rings with one another, and
1.5 finally, bringing the rings to bear with ends clamped between them.

With the known solution an easily managed method for connecting two flexible tube-like containers in the form of film tubes is known, which can be realized with simple devices or preferably by hand. In particular the known solution allows two open tubular film ends or tubular film end portions of the same diameter, to be reversibly connected to one another with minimal effort and in a sealed manner.

In practice however, it has been found that an undesirable release of the sought connection point with the two rings can occur and the known solution is also unsatisfactory with respect to the environmentally tight connection of the two open tubular film end portions.

Given this prior art, the problem addressed by the invention is therefore to provide, while retaining the advantages of the known solutions, amongst other things with low device outlay and avoiding safety clamps or clips, an improved method for producing a connection solution of the type mentioned, which cannot be undesirably released and which permits an improved, environmentally tight sealing of the two media-conducting containers relative to the environment.

This problem is solved by a method having the features of claim 1 in its entirety.

According to the invention and in accordance with the characterizing portion of claim 1, as the final additional method step for the above detailed method sequence, there is provision for the collar, which belongs to the ring, which is introduced into the other ring with its container to be everted in the direction of the other collar already wrapped around the other ring.

In this way, the connection point between the two rings is additionally secured towards the outside by means of the everted collar of the ring engaging in the other container and any undesirable release of the rings from one another is ruled out. Due to the concentric superpositioning of both collars viewed in the radial direction, the environmentally tight connection is furthermore improved and thus a virtually hermetic closure is obtained. This plays a role in particular when the two containers to be coupled to one another are to transport toxicologically hazardous substances or sensitive pharmaceutical substances, which must not come in direct contact with the atmospheric oxygen of the environment.

By means of the everting of the one collar on the other innerlying collar, in the region of the deflection of this everted collar the frictional connection between the film materials is increased, which enhances the secure connection. Is spite of this, the preferably manually produced connection with the everted collar can also be easily manually released again, so that the coupling according to the invention can be used for a variety of applications in situ. In particular, the method according to the invention for effective connection of two container systems does without costly hose clamps or connection clips, which helps to reduce the costs for the connection solution according to the invention with respect to the method for producing such a connection.

In one preferred embodiment of the method according to the invention, when the two rings are brought to bear a latching state is achieved, which is additionally secured by the everted collar of the ring, which engages in the other container with its ring.

The two rings used are designed flexible and are preferably provided with an identical diameter in their undeformed starting state. According to an advantageous embodiment, the rings used have an identical cross section, which is in particular rounded. They preferably consist of the plastics polyoxymethylene (POM), polyethylene (PE) or polyamide (PA).

Because the two tube-like flexible containers, at least with respect to their free end portions, are provided with an identical free passage diameter, the medium to be transported, such as for example bulk material, can pass the coupling connection between the two rings without obstacles.

The connection established between said flexible containers has a dynamic design with respect to the tightness, i.e. with increasing internal pressure the tightness increases. With increasing pressure the rings are, synchronous with the increasing stress pressure, pressed onto one another and the seal between the rings with the clamped film material is actively produced. The everted collar according to the invention increases the tightness by means of an additional deflection point in the region of the bearing of the two rings against one another, which again covers this bearing region.

The invention is explained in further detail below with reference to drawings. These drawings show in schematic and not to scale depictions:

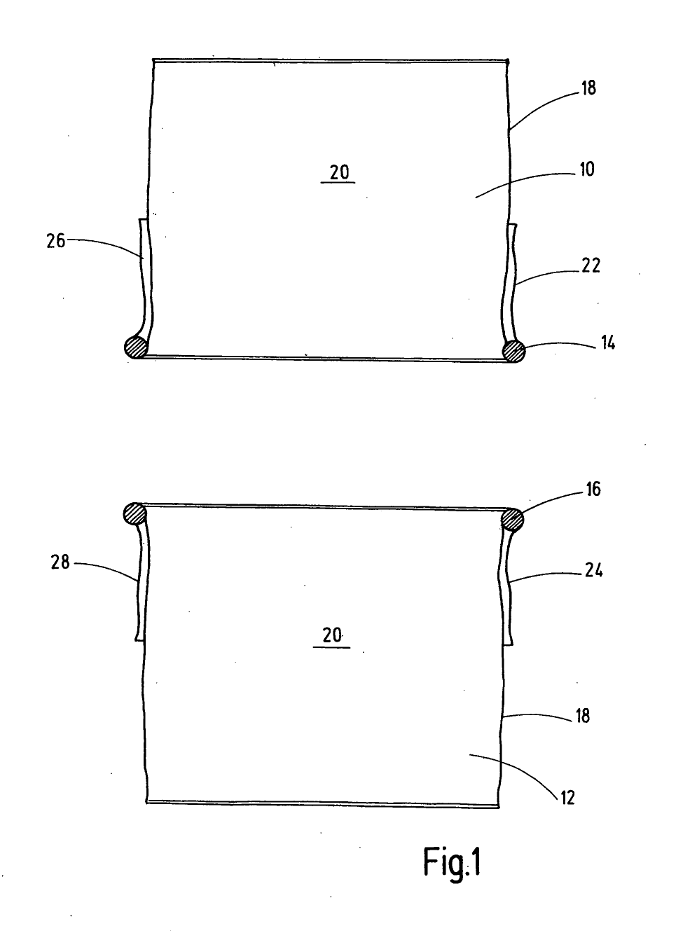

FIG. 1 two rings, aligned parallel to one another, according to a first exemplary embodiment with everted collar-like end portions of flexible containers;

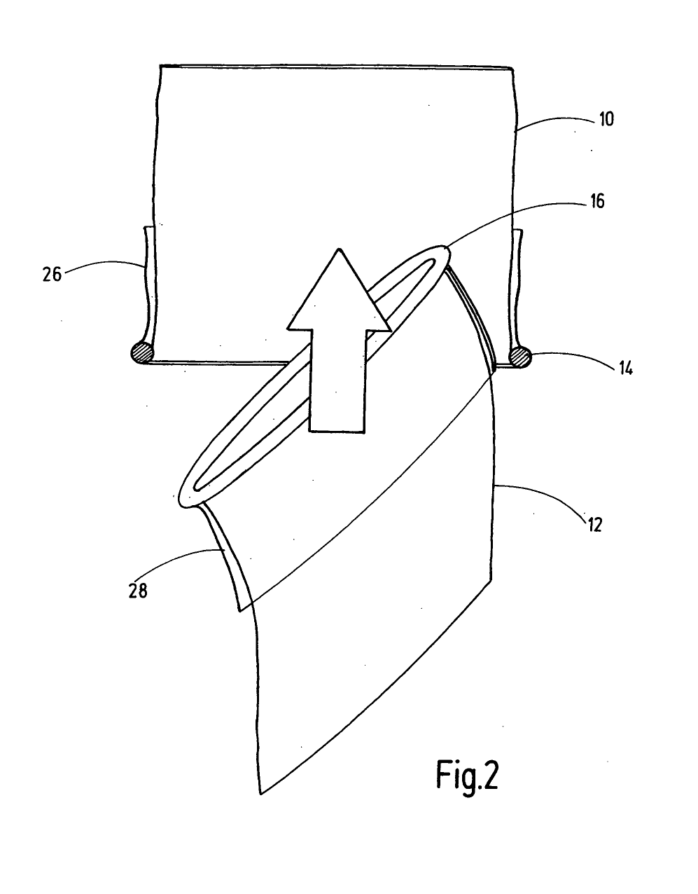

FIG. 2 the introduction of a first of the two rings according to the first exemplary embodiment through the second ring in the direction of the arrow;

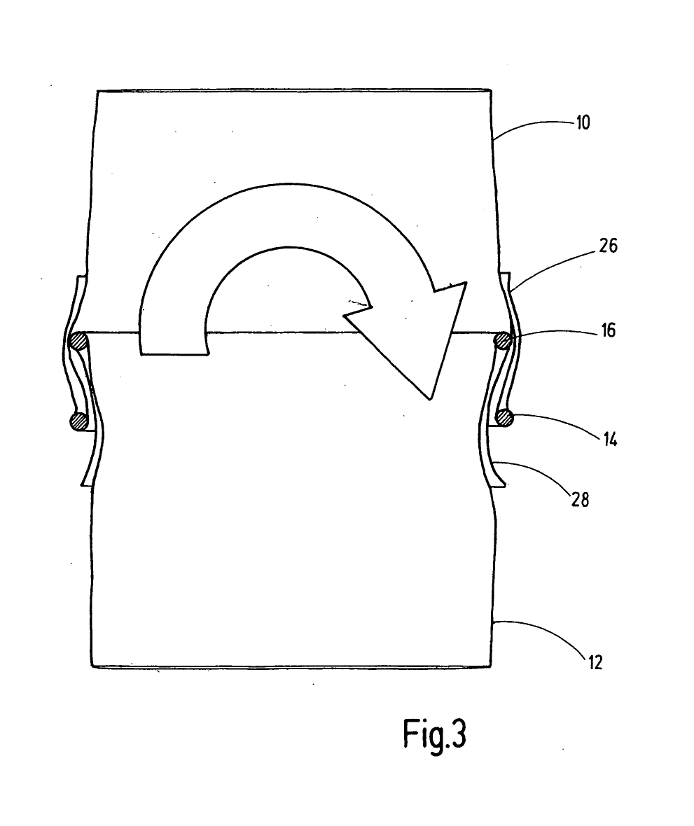

FIG. 3 rings, aligned parallel to one another, according to the first exemplary embodiment after the introduction and the moving apart again in the direction of the arched arrow depiction;

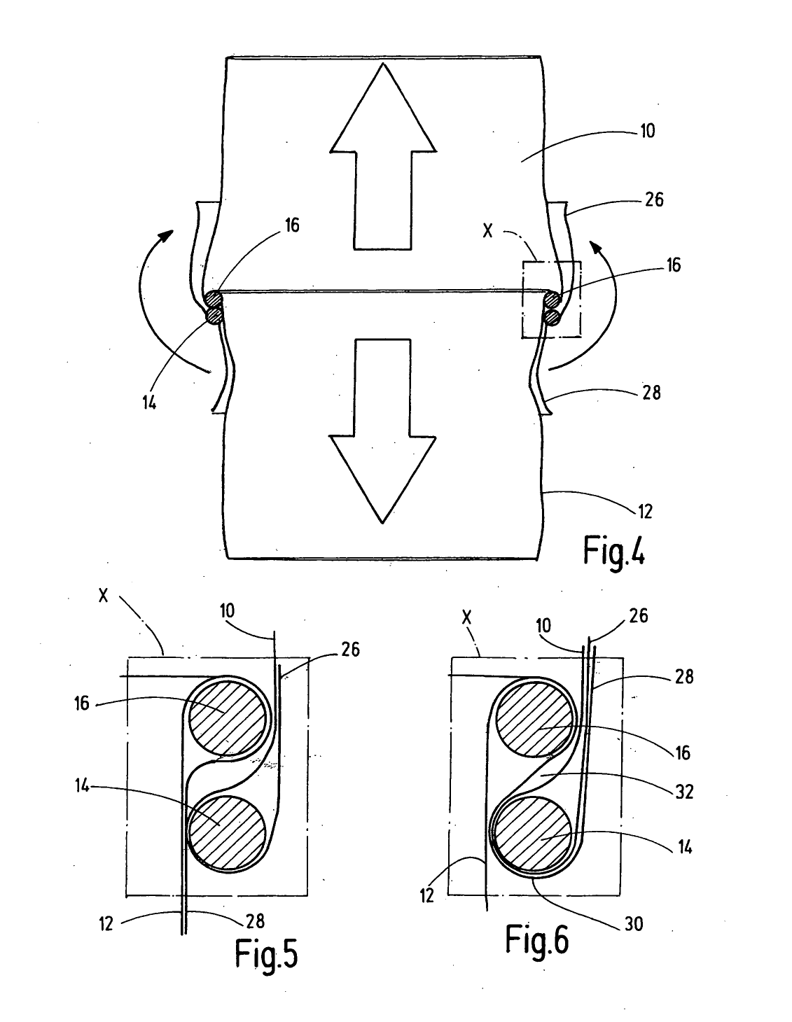

FIG. 4 the two rings with their respective open collar-like end portions, projecting in opposite directions, of the container according to FIG. 3 after the bringing to bear;

FIGS. 5 and 6 in an enlarged depiction a square image cutout according to FIG. 4 identified with an X, once in the starting state, as depicted in FIG. 4, and once in a depiction, in which in the arrow direction the bottom collar is everted upwards on the top collar; and

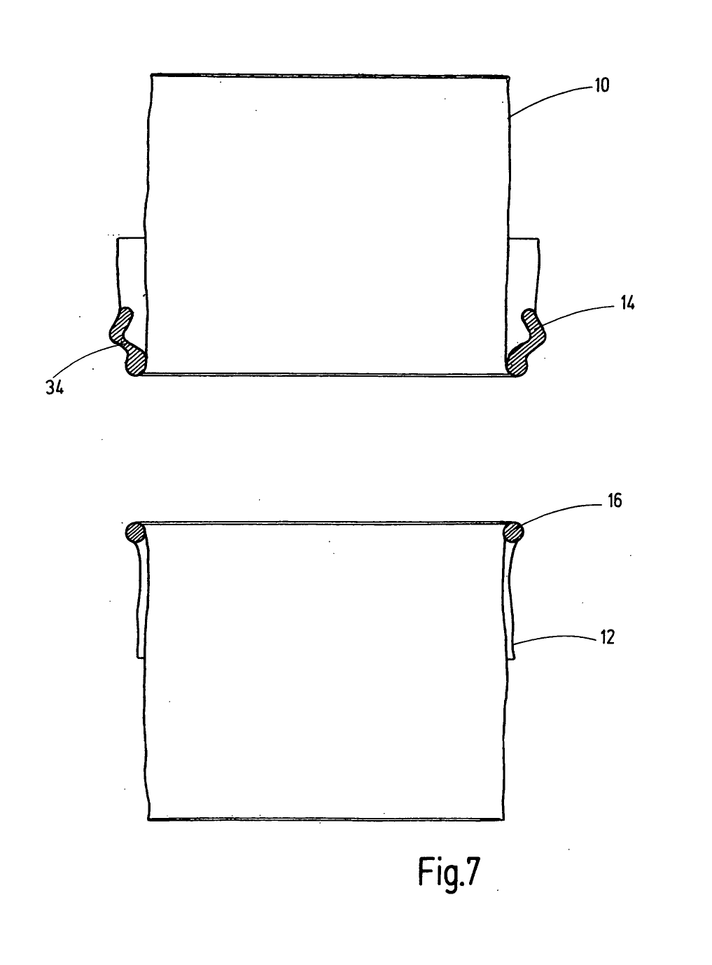

FIG. 7 two rings, aligned parallel to one another, according to a second exemplary embodiment with everted end portions of flexible containers, with the latching and securing operation being brought about in the same way as described above for the first exemplary embodiment according to FIGS. 1 to 6.

FIG. 1 shows in a schematic depiction a first container 10, which is to be connected, preferably in a media-tight manner, to a second container 12. The container 10 has a first ring 14 and the second container 12 has a second ring 16. The containers 10, 12 in particular consist of so-called endless tubular film, which with its film material 18 delimits an essentially cylindrical internal space 20, which serves for the passage of media, such as fluids or solids as bulk material. In FIG. 1 the containers 10,12, are shown only from their connection region and they extend onwards from the end region or connection region, which is not however depicted for the sake of simplicity. In particular the top free end of the flexible tube container 10 can be connected to a filling station which is not depicted in detail and the bottom end of the additional flexible tube container 12 can be correspondingly connected to a discharge station (not depicted).

The two rings 14, 16 preferably consist of flexible pliable plastic material and preferably have a circular ring-shaped cross section, to prevent damage to the sensitive film material 18. In addition, the two open tubular film end portions 22, 24, are laid at approximately 180 degrees, around the respective assignable ring 14 or 16 and thus form two annular collars 26, 28, which viewed in the axial direction project upwards and downwards with approximately the same overhang over the assignable rings 14 or 16. To form the two collars 26, 28 the two open end portions 22, 24 have thus been laid from the inside to the outside around the respective assignable ring 14, 16.

As can also be seen from FIG. 2, the bottom container 12 when viewed in the viewing direction of the figure is then introduced with its ring 16 into the free container opening of the other container 10 with its ring 14 and specifically following the defined arrow direction. This introduction into one another is possible because both the container 10, 12 and the corresponding rings 14, 16 are designed to be flexibly pliable. In particular the rings 14, 16 can be formed with corresponding dimensions to allow realization of the introduction operation and due to the elastic material forces they then return to their original cylindrical starting state in the form of a circular ring.

After a parallel and coaxial alignment of the two rings 14, 16 relative to one another an engagement scenario arises for the two containers 10, 12 according to the depiction of FIG. 3 and if one pulls the two containers 10, 12 apart from one another, which is symbolized by the arched arrow depiction, a bringing to bear of the rings 14, 16 then takes place with film material clamped therebetween according to the depiction of FIGS. 4 and 5, with FIG. 5 depicting on a larger scale and in a schematic manner the bearing relationship, as depicted in FIG. 4 and surrounded by a frame X.

In a final additional method step in accordance with the arrow depiction of FIG. 4, the collar 28, which is assigned to the ring 16, which as depicted is introduced into the other ring 14 with its container 10 in the direction of the other collar 26 already laid around the other ring 16 is then everted, with the finished everting operation being depicted in FIG. 6 in sections and in an enlarged depiction.

Furthermore, it can be seen from FIGS. 5 and 6 that due to the wrapped around open end portions 22, 24 in the form of the two collars 26, 28 of the first container 10 and second container 12 between the two rings 14, 16 two film lengths come to lie on top of one another, which in the latching state according to FIG. 4 are clamped between the two rings 14, 16 and are then fixed in this way.

While according to the depictions of FIGS. 4 and 5 the two open end portions 22, 24 in the form of the assignable collars 26, 28 are laid around essentially the same axial distance around the assignable ring 14, 16, it is seen that the subsequently further everted collar 28 according to the depiction of FIG. 6 is provided with a smaller axial extension than the surrounded collar 26 of the first container 10, which has to do with the fact that due to the deflection 30 in the bottom bend region of the first ring 14 a corresponding distance is required. It nevertheless becomes clear from the depiction of FIG. 6 that the shorter everted collar 28 with the collar 26 lying radially thereunder produces an effective seal towards the outside for the intermediate region 32 between the two rings 14, 16. Due to the thus additionally created seal it is also ensured that in the respective media-conducting internal space 22 of the two containers 10,12 the medium cannot arrive at the outside. In addition, in the region of the deflection of the collar 28, the friction between this collar 28 and the film collar 26 of the first container 10 is increased, which increases the adherence to one another of the two rings 14, 16 in their latching state. The everting of the collar 28 on the collar 26 can easily be realized manually, just like the operation of everting the collar 28 from its position shown in FIG. 6 to that according to position 5 for the purpose of releasing the container connection.

In the second exemplary embodiment according to FIG. 7, the first ring 14 of the first container 10 is provided on its inner side with a circumferential recess 34, which is formed according to the curvature of the round cross section of the second ring of the second container 12. Said recess 34 is arranged open relative to the axial side of the first ring 14 and this ring 14 has a camber, so that an entrance cross section is formed which is smaller relative to the external diameter of the second ring 16. Thus in a comparable latching state of the two rings 14, 16 with one another according to the depiction of FIG. 4 the second ring 16 can be securely fixed in the recess 34 of the first ring 14. With this solution an improved latching of the second ring 16 in the first ring 14 is achieved.

1. A method for connecting two flexible tube-like containers (10,12), in particular for environmentally tight connection of two open tubular film end portions (22, 24), comprising at least the method steps
1.1 everting a first open end portion (22) of a first container (10) from the inside to the outside about a first ring (14) in such a way that a collar (26) is created which, viewed in the axial direction, extends away from the first ring (14) and at least partially surrounds the first container (10),
1.2 everting a second open end portion (24) of a second container (12) from the inside to the outside about a second ring (16) in such a way that an additional collar (28) is created which, viewed in the axial direction, extends away from the second ring (16) and at least partially surrounds the second container (12),
1.3 introduction of the one ring (16) into the respective other ring (14) with its connected container (10),
1.4 parallel and coaxial alignment of the two rings (14, 16) with one another,
1.5 bringing the rings (14, 16) to bear with film material (18) clamped between them, characterized in that as the final additional method step
1.6 the collar (28), which belongs to the ring (16), which is introduced into the other ring (14) with its container (10) in the direction of the other collar (26) already laid around the other ring (14), is everted.

2. The method according to claim 1, characterized in that when the two rings (14, 16) are brought to bear a latching state is achieved.

3. The method according to claim 1, characterized in that the two rings (14, 16) are designed flexible and in their undeformed starting state are provided with an identical diameter.

4. The method according to claim 1, characterized in that the two tube-like, flexible containers (10, 12) are provided with an identical free passage diameter at least with regards to their respective free end portions.

5. The method according to claim 1, characterized in that the two open end portions (22, 24) are laid around an essentially identical axial distance about the assignable ring (12, 14) with formation of the respective assignable collar (26, 28).

6. The method according to claim 1, characterized in that the collar (28) to be everted fully surrounds the collar (26) which has already been wrapped around in such a way that viewed in the axial direction the everted collar (28) is provided with a smaller axial extension than the surrounded collar (26).
